(19) United States
(12) Patent Application Publication
(10) Pub. No.: US 2015/0334094 A1
(43) Pub. Date: Nov. 19, 2015

(54) DISTRIBUTED COMPUTING SERVICE PLATFORM FOR MOBILE NETWORK TRAFFIC

(71) Applicant: Akamai Technologies, Inc., Cambridge, MA (US)

(72) Inventors: Rangan V. Suresh, Acton, MA (US); Ravi S. Aysola, Acton, MA (US); Brian B. Mullahy, Leominster, MA (US); James V. Luciani, Acton, MA (US)

(73) Assignee: Akamai Technologies, Inc., Cambridge, MA (US)

(21) Appl. No.: 14/604,607

(22) Filed: Jan. 23, 2015

Related U.S. Application Data
(60) Provisional application No. 61/993,442, filed on May 15, 2014.
(60) Provisional application No. 61/993,460, filed on May 15, 2014.
(60) Provisional application No. 62/002,029, filed on May 22, 2014.
(60) Provisional application No. 62/007,646, filed on Jun. 4, 2014.

(51) Int. Cl. H04L 29/06; H04L 29/08; H04L 9/32

(52) U.S. Cl. CPC H04L 63/0471; H04L 63/168; H04L 9/3263; H04L 67/02

(57) ABSTRACT

Described herein are systems, methods, and apparatus for processing network packet data in a distributed computing platform, such as a content delivery network, to provide services to mobile network operators and/or their mobile subscribers. According to the teachings hereof, distributed computing resources can be organized into a service platform to provide certain value-add services—such as deep packet inspection, transcoding, lawful intercept, or otherwise—using a service function chaining model. The platform resources are preferably located external to the mobile network, on the public Internet. The platform preferably operates on and processes traffic entering or exiting the mobile network. In some embodiments, the service platform is able to establish an encrypted channel between itself and the mobile client through the mobile network, e.g., using content provider key and certificate information available to the platform (but which may not be available to the mobile network operator).

### CROSS REFERENCE TO RELATED APPLICATIONS

This application is based on and claims the benefit of priority of U.S. Provisional Application No. 61/993,442, filed May 15, 2014, U.S. Provisional Application No. 61/993,460, filed May 15, 2014, U.S. Provisional Application No. 62/002,029, filed May 22, 2014, and U.S. Provisional Application No. 62/007,646, filed Jun. 4, 2014. The disclosures of all of the foregoing applications are hereby incorporated by reference in their entireties.

This patent document may contain material subject to copyright protection. The copyright owner has no objection to the facsimile reproduction by anyone of the patent document or the patent disclosure, as it appears in Patent and Trademark Office patent files or records, but otherwise reserves all copyright rights whatsoever.

### BACKGROUND

1. Technical Field

The teachings hereof relate generally to distributed data processing systems, to service platforms for network operators, and to service function chaining.

2. Brief Description of the Related Art

Network operators, and in particular mobile network operators, want to offer various value added services to their customers. Examples of such services include deep packet inspection (DPI), parental controls, SSL traffic optimization, network address translation (NAT) and others. In the past, network operators often deployed specialized network elements to be able offer a particular service. However, this approach is inflexible, expensive to operate and does not scale well.

As a result, recently network operators have moved towards an abstracted approach referred to as service function chaining or service chaining. In this approach, each of the supported services can be modeled as combination of one or more service functions (SF), where the role of each service function is to perform a specific task on a network packet or set of packets. For a given service, the service functions are applied in a sequential or parallel manner, i.e., by directing network traffic through them in a specified manner. This technique is known as service function chaining, and those chains are typically referred to as service function chains. In a given network there may be multiple service chains. For example, a network may provide three service functions: a NAT service function, a DPI service function, and an SSL optimization service function. With these service functions, several combinations of service chains can be formed from these independent service functions:

$$\begin{matrix}NAT \\ NAT + DPI \\ NAT + DPI + SSL Optimization \\ DPI + SSL Optimization \\ …\end{matrix}$$

The entity that links services into service chains and selects the appropriate chain for the received traffic is typically called a ‘classifier’ (also referred to as a ‘service classifier’). The classifier may also perform a load balancing function to select the least loaded service function node or to wean traffic away from a service function node that might need to be taken out of service. There can be multiple active classifiers at any time. The service function chains, including the service functions that they include, are dictated by a static configuration. To change the chain, the configuration must be edited (for example by a system user) and installed at the classifier.

Service classifier and service functions may or may not be physically co-located. Each of them can be an independent process in one physical node or they may be virtualized. In order to identify service functions uniquely, each of them is typically given a unique identifier known as service function identifier. In addition to the service function identifier, each service function carries service-function-locater attribute. This service-function-attribute can be an Internet Protocol (IP) address, fully qualified domain name (FQDN) or Layer 4 port number. Service classifier and other service-functions use this locater as the destination address of the traffic. To effect the service function chain, a data plane typically carries the actual traffic; a control plane is typically used to manage and coordinate the traffic flow amongst service nodes.

Various aspects of service function chaining are currently being standardized in an IETF working group (Service Function Chaining working group).

### BRIEF DESCRIPTION OF THE DRAWINGS

The teachings hereof will be more fully understood from the following detailed description taken in conjunction with the accompanying drawings, in which:

FIG. 1 is a schematic diagram illustrating an embodiment of a known distributed computer system configured as a content delivery network (CDN);

FIG. 2 is a schematic diagram illustrating an embodiment of a machine on which a CDN server in the system of FIG. 1 can be implemented;

FIG. 3 is a schematic diagram illustrating an embodiment of a service provider platform that provides value-added service(s) to users associated with a mobile network operator;

FIG. 4 is a schematic diagram illustrating an embodiment of a dynamic service chaining architecture for use in the platform shown in FIG. 3;

FIGS. 5A-B are a schematic diagram illustrating an embodiment of packet processing logical flow, which may operate in the dynamic service chaining architecture shown in FIG. 4; and,

FIG. 6 is a block diagram illustrating hardware in a computer system that may be used to implement the teachings hereof.

### DETAILED DESCRIPTION

The following description sets forth embodiments of the invention to provide an overall understanding of the principles of the structure, function, manufacture, and use of the methods and apparatus disclosed herein. The systems, methods and apparatus described herein and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, publications and references cited herein are expressly incorporated herein by reference in their entirety. Throughout this disclosure, the term “e.g.” is used as an abbreviation for the non-limiting phrase “for example.” The term “or” is intended to be inclusive; in other words, unless specified otherwise or clear from context, the phrase “X or Y” is intended to represent any permutation thereof, including X alone, Y along, both X and Y. The articles “a” and “an” are intended, unless specified otherwise or clear from context, to include one or more.

Described herein are systems, methods, and apparatus for processing network packet data using a distributed computing platform, such as a content delivery network (CDN), in order to provide services to mobile network operators and/or their mobile subscribers. According to the teachings hereof, distributed computing resources can be organized into a service platform to provide certain value-add services—such as deep packet inspection, transcoding, lawful intercept, or otherwise—using a service function chaining model. The platform resources are preferably located external to the mobile network, preferably on the public Internet. The platform preferably operates on and processes traffic entering or exiting the mobile network. Such traffic may be upstream traffic, such as content requests from client devices, or downstream traffic, such as origin server responses to content requests.

Preferably, servers in the computing platform provide proxy server functionality, terminating connections from mobile clients in the mobile network. Such servers use can content provider key and certificate information available to the platform operator (but which may not be available to the mobile network operator) to establish an encrypted channel between themselves and the mobile client device. The data in the channel is decrypted and the service function chains in the platform process it to provide desired services. As mentioned, this processing can occur on upstream (e.g., client request) traffic that is obtained from the encrypted channel, as well as on downstream traffic (e.g., origin response) before sending it through the encrypted channel to the mobile client device.

Service Function Chaining Architecture with Service Provider Platform

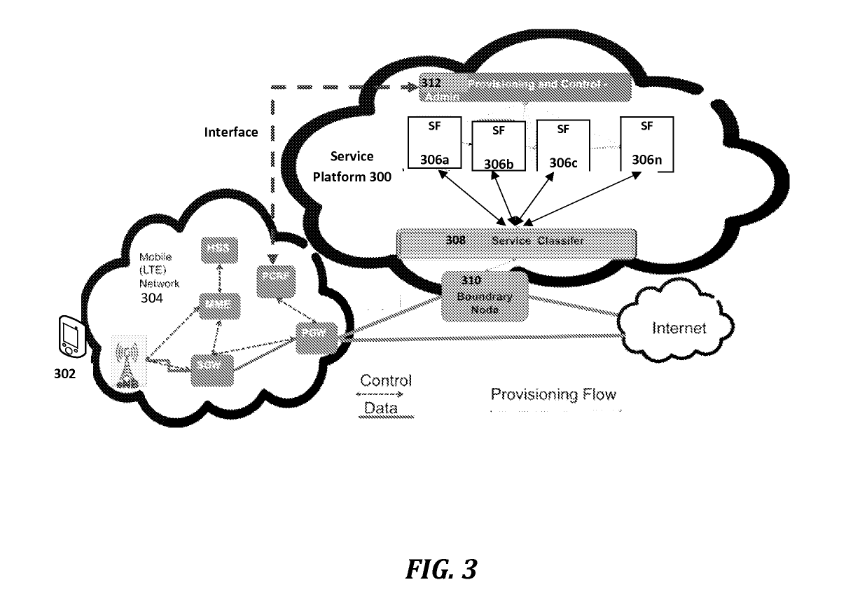

FIG. 3 illustrates an embodiment of platform 300 operated by a service provider (which is preferably a content delivery network service provider though the teachings hereof are not necessarily so limited) to provide value added services (VAS) to an end network operator subscriber. It should be noted that while FIG. 3 illustrates a mobile network 304, the teachings hereof may be applied regardless of the type of network and network operator. In the description that follows, familiarity with conventional mobile network elements is presumed.

In the following text, the term “service provider” is used to refer to the service provider associated with the platform 300. The term “network operator”, “network provider” or “mobile network operator” is used to refer to the entity operating and otherwise associated with the mobile network in FIG. 3.

With reference to FIG. 3:

The Provisioning/Control-Admin Interface is for policy, control and provisioning. This entity has a communication channel to a network element in the operator network 304—in this example, the network element is the Policy & Charging Rules Function (PCRF). This channel allows the service provider platform to send information to the network operator about the services that it performed and the end-user subscriber that it performed them for. For example, the service provider platform 300 can send a network subscriber identifier along with information identifying the services provided for that user. In this way, the service provider can charge the network operator for service and the network operator can charge its subscribers for the services provided in a service function chain.

The service classifier 308 is a node that classifies packets and builds service function chains.

The service function nodes 306a-n (labeled SF) host one or more service function instances built internally, configured from third party services, or otherwise. Some of the SF nodes 306 may be third party service nodes that implement certain functions for the value added service function chain.

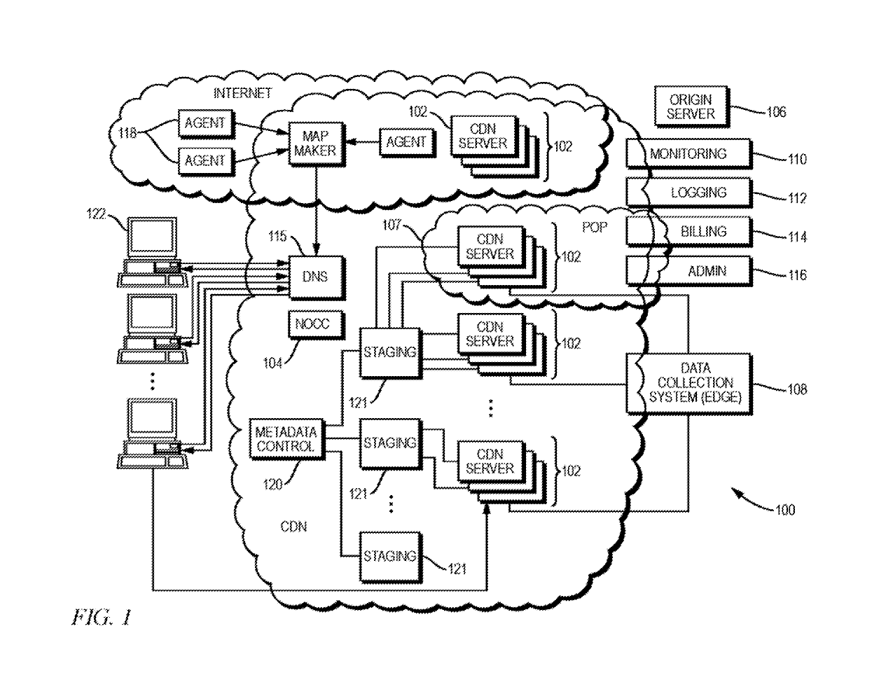

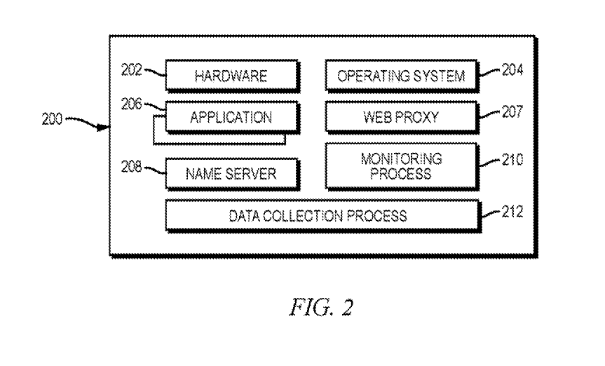

The boundary node 310 is the entry/exit point for traffic coming from the PDN Gateway (PGW) to the service provider platform 300, and for traffic going from the service provider platform to the PGW. Notably, the boundary node 310 may be, in some cases, a content server in a distributed content delivery platform such as a content delivery network (CDN). Typically, CDNs deploy content servers running an HTTP proxy and a providing a local content cache. The boundary node functionality can thus be layered or incorporated into machines that are part of this deployed platform. More information about content delivery networks and content servers is provided at the end of this disclosure and in FIGS. 1-2. With reference to those drawings and associated description, the boundary node 310 may be a CDN server 102 as described there. For encrypted traffic (such as SSL/TLS encrypted traffic or IPSec traffic) preferably the boundary node 310 decrypts the packets before sending them to the classifier 308. To this end, for session layer encrypted traffic, the boundary node 310 (and the service platform 300 generally) can use or has access to SSL/TLS private keys and public key infrastructure certificates (e.g., X.509) for the content providers who use the CDN (and the platform 300) to deliver their web properties or other online content. Also, the boundary node 310 may in some cases employ mechanisms to decrypt SSL/TLS traffic to the client without having locally-accessible private keys by offloading the decryption of an encrypted pre-master secret in the SSL/TLS handshake to an external server, as described in U.S. Patent Publication No. 2013/0156189, the teachings of which are hereby incorporated by reference.

The boundary node 310 can also establish a separately negotiated encrypted channel with the service classifier 308 to be able to securely send the data onwards. Likewise, the classifier 308 can send data to the boundary node 310 in an encrypted channel, after processing is performed.

Generalizing, in the upstream direction, a boundary node 310 can receive encrypted traffic that originated from a mobile network subscriber's client device 302 and that is egressing the mobile network 304, e.g., through PGW or other network element. The boundary node 310 preferably has access to decryption information such as SSL/TLS private keys and certificates of a content provider to which the mobile client is directing traffic. For example, the mobile client may be sending an HTTP request to obtain content from site www.example.com and the request may be intercepted or may be directed to the boundary node 310 (e.g., because of DNS aliasing which causes the client's recursive DNS server to resolve www.example.com to a CDN server, as is known in the CDN art). The boundary node 310 is able to establish a secure (SSL/TLS) session with the client device 302, decrypt traffic from the client (e.g., such traffic containing such things as HTTP requests), and then perform certain value-added-services on traffic from the client device 302. The traffic then proceeds to a content provider origin in the Internet, or is returned to the mobile network 304 and/or the client device 302, depending on the particular function. The service platform 300 can likewise perform value-added services on downstream traffic headed to the client device 302, encrypting it in the session before sending it through the gateway to the client device 302.

The Policy and Control/Admin 312 is responsible for the providing the admin interface for the service function chaining domain. Preferably it also provisions identifiers for the service function nodes 306a-n, service function chains, and classification rules to various service function nodes 306a-n and service classifier 308. The interfaces (to the PCRF, the SF nodes 306a-n, and/or the service classifier 308) is implementation dependent and can be RESTful.

FIG. 3 also shows a mobile network 304 with conventional mobile network components, such as a Packet Data Network Gateway (PDN Gateway or PGW), which serves as the anchor point for user-equipment (also referred to herein as a client device 302) sessions towards the data packet network and manages policy enforcement features; mobile management entity (MME) for tracking the user equipment (client device) and facilitating voice and data sessions; a serving gateway (SGW), to manage user-plane mobility; a Home Subscriber Server (HSS), for maintaining a subscriber database needed by other network elements; and as mentioned above, Policy & Charging Rules Function (PCRF), for maintaining policy and charging rules, including subscriber information (such as account data and services the subscriber has signed up for), bearer and Quality of Service (QoS) information associated with end-points within the operator network. The rules and policies are typically pushed/pulled from the PCEF (Policy & Charging Enforcement Functions) such as PGW, Gateway GRPS Support Node (GGSN), CDMA Home Agents of HRPD Serving Gateway (HSGW). In the systems and methods described herein, these components function in a conventional manner, as modified by the teachings hereof.

FIG. 3 also shows an interface from the PGW to the Internet and an interface from PGW to the service platform 300 (or more particularly, to the Boundary Node). These may be LAN connections such as an S(Gi) interface. However, those particular network configuration and interfaces are not limiting to the teachings hereof. Further, it should be noted that while FIG. 3 depicts a service provider platform 300 external to the network operator, many of the teachings hereof also apply where a network operator establishes its own platform as part of its own network, or invites deployment of the service platform into the mobile network 304 itself.

It should be understood by those skilled in the art that while FIG. 3 illustrates an LTE network embodiment (sometimes referred to as 4G or 3G LTE/SAE), the teachings hereof apply also other mobile networks, including prior known and hereafter known radio access network and core network variants and evolutions. For example, the teachings hereof may be to offer packet processing services to a 3G network, which generally has a CDMA-compliant radio access network with NodeB stations and RNCs and a core network using a Generalized Packet Radio System (GPRS). GPRS is provided by a Serving Gateway Support Node (SGSN) and Gateway GPRS Support Node (GGSN) providing a gateway to the external Internet/packet-data-networks. The teachings hereof may also be used with so-called 3.5G networks (in particular UMTS/HSPA and HSPA+networks), with 2G/2.5G (GSM/GPRS/EDGE) networks, with Femtocell networks (in which Femto Gateways provide the interface between the mobile network and external packet data networks), with Internet Multimedia Subsystems (IMS) networks (in which CSCF gateways provide an interface to external packet data networks), and/or with WiMax deployments (in which an ASN Gateway provide an interface to external packet data networks). The foregoing are merely some examples. These and other mobile network technologies are known in the art.

Service Chaining Architecture Detail

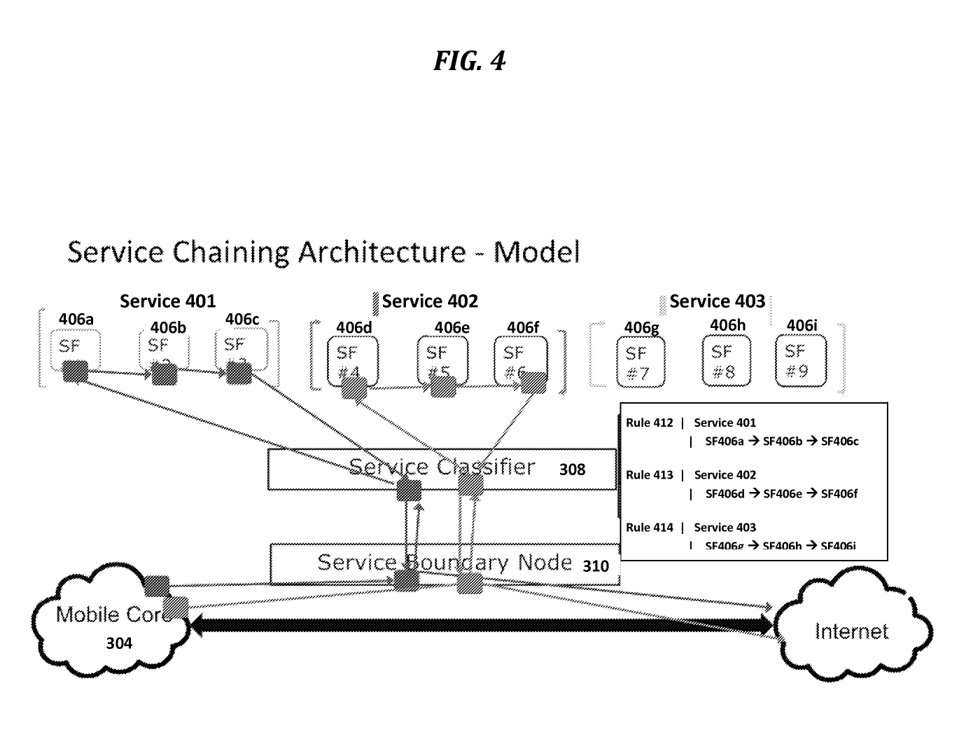

FIG. 4 below illustrates in more detail an embodiment of a service chaining architecture within the service provider platform 300 of FIG. 3. The service chaining architecture of FIG. 4 provides a framework for dynamic and agile inclusion, modification, and/or deletion of services based on business needs of a network operator. Many of the elements in FIG. 4 correspond to those introduced with respect to FIG. 3, but will now be described in additional detail.

In FIG. 4, the service function (SF) nodes 406a-i are like the SF nodes 306a-n shown in FIG. 3 and perform the same role, but have been allocated to particular service function chains illustrated in FIG. 4. As noted, a service function is generally responsible for performing a particular action or processing on incoming traffic, e.g., one or more packets. The value-added service offered by the service provider platform 300 typically involves chaining together one or more service function. A service function has a type describing what function it performs or is capable of performing. A service function is preferably identified by a service function identifier that is unique in the domain. Multiple instances of the same service function type may be (and preferably are) running in the platform 300 at a given time, to provide scale and high availability. Each service function instance is preferably identified by a unique service function instance ID in the system. An instance of a service function is hosted in a given node, which may be physical machine or a virtual machine. An instance typically represents an application, process or thread, or grouping thereof, running in such a machine. A service function node is typically associated with a service locator for reachability and service delivery.

Examples of service function types include (some of these apply to mobile applications, other apply more generally):
Blocking Illegal content—for example, some instances of peer to peer traffic.
Parental control
Carrier zero-rated billing rules & differentiated billing rules
Mobile SSL Content adaptation (transcoding, trans-rating, trans-sizing)
Dynamic quality of service (QoS) & traffic flow template (TFT) filtering rules
   For example, setting up bearer channels with specific QoS characteristics for particular traffic, e.g., traffic from or to a particular end-user subscriber's client device.
   This Service Function may aid network elements in prioritizing or in some cases deprioritizing particular traffic, for example by inserting a code point into downstream traffic that signals a network gateway (e.g., PGW) to apply certain QoS characteristics and thereby select a particular bearer channel.
Header enrichment (e.g., for HTTP headers)
Carrier Service (Sponsored data, sponsored ads)
Mobile Device Optimization
VoC (Video over cellular)
Deep packet inspection (DPI)
Firewall
Lawful intercept

The service classifier 308 (also referred to as classifier or SF chain classifier) classifies packets. Preferably it does this based on a packet header or payload contents, according to a policy rule. The rule could specify a statically configured chain of service functions for the given packet header/payload; the rule could also specify that a given set of service functions are to be performed, but allow the service classifier to build the chain dynamically, as is described in more detail below.

Continuing with FIG. 4, the boundary node 310 is preferably a physical or virtual element that connects a given service function chaining domain to another such domain or to a non-service function chaining enabled domain. It typically handles ingress traffic (as the first node to receive traffic from other domains) and/or egress traffic (as the last node to send traffic to other domains). As noted before, in some embodiments, the boundary node 310 is realized in a content server in a CDN, e.g., a deployed proxy cache.

A service function chain (SFC), which is sometimes referred to simply as a ‘service,’ generally defines a set of service functions to be applied to traffic. The order of functions may be linear or parallel. The service classifier populates an SFC by assigning service function instances that will perform each service function in order to create an instance of the SFC. FIG. 4 shows three examples, Services 412, 413, 414. An instance of an SFC is a service function path (SFP). The assigned instances are associated with their host node, and therefore by assigning instances the service classifier is implicitly assigning particular nodes to perform each service function. The particular SFC to use can be selected as result of classification based on policy at the Service Classifier. Multiple instantiations of SFCs may be running simultaneously in the platform 300.

As noted, a service function path (SFP) is an instantiation of a SFC in the network. The path typically starts at the service classifier and steps through the selected service function instances. FIG. 4 illustrates two different SFPs.

Service Function Topology—Multiple topologies are possible for service chaining. The selection of a topology can be based on the services and/or based on business continuity. The following exemplary topologies can be supported:
Daisy Chain—In this case, the service function instances have intelligence to forward the packet to the next service function instance (and service function node) as defined in the SFC. The SFC can be dynamically passed along to the service function instance by the service classifier, which would tell the instance where to send the packets next.
Star topology—In this case the service function instances perform the processing and passes the result back to service classifier which takes care of invoking the next service function instance in the path.
Hybrid—a hybrid of daisy chain and star topology can be utilized in which an interconnection layer is interposed between the service classifier and service function instances, acting as a cross connect. Service function instances return packets to the interconnection layer, which then routes the packets to the next service function instance in the path.
Service Function as a sink—In this topology, the Service Function instance gets the packet from the service classifier (or other service functions) and consumes it totally without forwarding it further. An example of such a service function is in case of lawful intercept.

Dynamic Service Chaining

It is the job of service classifier 308 to define the chain of service functions (realized in service function nodes 406a-i) for each service offering. According to this disclosure, the service classifier 308 can instantiate the chains dynamically. In other words, enough intelligence can be coded (natively) or configured (e.g., via configuration policies) into the service classifier 308 to build service chains dynamically instead of using a static configuration. With a static configuration, the type and order of service functions are set by configuration, and the service classifier 308 instantiates a chain by determining the particular service function instances (and thereby, the nodes 406a-i) to perform each service function in the configured order. With dynamically configured chains, the service classifier 308 not only selects the particular service function instances at the time of packet processing, but also defines the order and/or type of service functions that make up the chain without compromising the desired functionality of the chain. In some cases, the configuration at the service classifier 308 may specify the degree of flexibility that the service classifier 308 is allowed to have. For example, the configuration may specify that a particular service function is optional, may be re-ordered, or may be downgraded to a lesser functionality. Dynamic service chaining in this sense is a service overlay on top of the virtualized infrastructure but is distinct from virtualization and orchestration.

Dynamic service chaining functionality applies equally to physically co-located SFC architecture components and to ones that are hosted on geographically dispersed data centers.

When a service classifier 308 receives inbound packets, it can dynamically build a particular SFC for the packets, based on a variety of things, including policy rules at the classifier, header and payload information extracted from the packets (which as noted above were preferably decrypted by the boundary node 310). Chaining of service functions dynamically to form a service-function-chain can be done in multitude of ways. A few examples of dynamic chaining are given below.

### Example 1

### Dynamic Service Function Re-Ordering

The service classifier 308 can obtain information about the service functions instances, their capacity and load, via capability exchange (described below) between the service-functions and the service-classifier. This exchange can also provide the location parameters of each of the service-function instances (which is reflected by the location of their host nodes). With that data at hand, the service classifier 308 can apply service functions in a different order than otherwise dictated by configuration—which might be considered a default—in order to optimize performance.

If an SFC is configured to permit applying service functions in a different order than as statically configured, the service classifier 308 can dynamically select service-functions such that overall latency of the service-chain application is reduced. For example, assume the service classifier 308 traffic inbound at the boundary node 310 and determines that a particular static configuration should be invoked. (The service classifier 308 may make this determination because the traffic is from a given subscriber, IP address, or the traffic directed to a particular content provider or content provider application, or other criteria.) Assume further that the particular static configuration dictates the service functions in the chain that correspond to SF 406a, SF 406b, SF 406c (e.g., see Rule 412 in FIG. 4). Based on capability exchange, assume that the service classifier 308 determines that the least loaded instance (which is preferably reflected by the load on the host node) is SF 406b and that SF 406b is closer to SF 406c than SF 406a. The classifier can build a new SFC (without changing the overall functionality) as SF 406a, SF 406c, SF 406b instead to minimize the overall latency. In this way, the network availability and topology of the service function instances is taken into account when constructing an SFC. This approach applies to service functions that can be reordered without compromising the functionality of the overall service. An example of such dynamic service function reordering is as follows: assume a service function chain consists of service function types: Deep Packet Inspection, Transcoding, NAT. If the least loaded NAT service function instance happens to be closer to DPI service function instance, then it is acceptable to execute DPI, NAT and then the Transcoding service function, as the NAT and transcoding are two orthogonal service functions.

Generalizing, any two service functions may be re-ordered if each does not depend on the results or outcome of the other service function. This is often the case if two service functions operate on different elements of a packet (e.g., a header vs. a payload, one header vs. another header). However, certain service functions that have the ability to drop packets, such as a firewalls or parental control filtering, are preferably not reordered because pushing them to occur later in a chain might result in wasted processing, since the firewall or filter might ultimately determine that the packets should be discarded.

If there are multiple service functions in between the service functions that the classifier wants to re-order, then the classifier checks to determine whether the criteria are satisfied as to the intervening service functions. For example, assume an SFC with four service functions, SF1 through SF4. If the default service chain is SF1, SF2, SF3, SF4 and the service classifier determines that the optimum path is SF1, SF4, SF2, SF3, then the classifier checks that SF4 does not depend on the outcome of SF2 or SF3.

### Example 2

### Dynamic Functionality Downgrade

In some cases, the service classifier 308 can build service chains that downgrade the functionality of the chain (or of a particular service function) without completely rejecting the request. For example, assume that one of the service functions in a chain transcodes the content at a particular resolution level and/or bitrate (e.g., corresponding to an HD standard) but due to lack of resources (e.g., CPU utilization, memory constraints, or other latency creating issue) that the service function can't be offered at the time that the service classifier is building the chain. In such cases, service classifier can choose to insert a service function that transcodes the content at a lower bitrate or resolution until the service function recovers its resources. The service classifier may insert the service function by selecting a service function identifier for the downgraded function; note that it is possible that the service function id for the “full-feature” and the “downgraded” functionality may actually point to the same service function instance, but with different task parameters (e.g., lower-resolution output required vs. HD resolution output required). Similarly, if the service function involved optimization of content (e.g., front-end optimization of HTML and web content, mobile-specific optimizations, resizing of images, or the like) but resources were not available, the classifier may decide to invoke a service function that performs fewer optimizations—preferably a subset of optimizations that are likely to provide the most benefit for the requesting client device—than otherwise would be done.

### Example 3

### Service Function Instance Downtime

In some circumstances, certain service functions may need to go offline, e.g., for maintenance reasons. A dynamic service classifier 308 can bypass that service function and build a new SFC until that service function is alive again. This capability eases the operator's ability to take services offline without having to update service chains of several thousand clients.

### Example 4

### Dynamically Altering Service Functions in a Chain Based on Output of Previously Executed Service Functions

In this technique, the service classifier 308 can modify the service function path (to insert, or substitute, a service function later in the path, or make other change) based on the output of service functions earlier in the path. For example, based on the output of a DPI service function, a new service function such as a lawful intercept may be dynamically inserted into the path. The triggering output of the DPI may be based on, for example, a particular website being accessed (domain name) or a particular geographic region where the data is obtained from or being requested from (source IP address or geo tag).

Dynamically building service chains using the exemplary techniques described above may be used to provide a variety of advantages, such as:
Dynamic inclusion of new instances of service functions for better load balancing.
Dynamic inclusion of new services and let service classifier build service chains on the fly.
Better usage of available resources.
Formation of new service chains, if necessary and feasible, based on the input from the previous iteration of service chain application.
Variable billing based on the level of services (within the service chain) applied.
Easier configuration for the operator especially when number of services offered is fairly large.
Permits selectively including certain services for certain clients while retaining rest of the service chain for all others. For example, if lawful intercept needs to be applied to a subset of customers while retaining all other service functions for the entire customer base, dynamic chaining makes that feasible without having to build two separate chains.

Capability Reporting by Service Functions

In general, each service function instance has certain capabilities and resource limitations associated with it. Some of these may be inherent in the instance, others may be a result of the host node for the instance. Two service function instances that perform the same task can potentially have varying levels of resources. Lack of sufficient resources will limit number of requests that can be served by that service function instance. To build SFCs dynamically, service classifiers use capability information from service function instances, along with information in the packets themselves.

The term ‘capability’ as used herein refers comprehensively to the supported features by a particular service function type as well as the available resources or capacity of the service function instance of that type.

Preferably the service classifier 308 learns about the capabilities of service function instances in real time. Each of the service function instances hosted in nodes 406a-i preferably knows the identity of their associated service classifier. Such capability reporting can be performed either periodically or on an event-driven basis, e.g., whenever there is a significant change. In some cases, it can be left to the discretion of the service function instance, e.g., the service function may want to report when other activity has died down. In one implementation, the service functions can form a hub and spoke relationship with the service classifier acting as hub and service functions playing spoke role. Each service function instance can send its capability data to its associated service classifier, or service classifiers (plural) should that instance be affiliated with multiple classifiers. This spoke connection can be a RESTful API between service function instance and service classifier. Alternatively, it can be a multicast mechanism where all service functions join a well-known multicast group for which service classifier is the recipient of group messages, e.g., in a publish/subscribe fashion. Advanced Message Queuing Protocol (AMQP), Internet Group Management Protocol (IGMP), and like protocols can be used for such communications.

Some of the capabilities and characteristics that can be advertised by the service function instance are:
Supported service function types
Maximum transactions
Number of current active transactions
Current CPU usage
Current memory usage
Latency between service-function and service-classifier
Geographic location
Network distance (e.g., based on measured latencies and round-trip-times) from other service functions

As can be seen from the list above, some of these capabilities and characteristics of the instance are in effect reflecting the capabilities and characteristics of the hosting node for the instance.

Capability reporting aids the service classifier 308 in knowing the overall capacity of the service function instances and of the SFC before it needs to construct a particular SFC. It also helps in equitable load balancing of incoming requests among SFCs and/or individual service functions instances. Further, capability reporting also aids the service classifier in formation of alternate chains should one or more service function instances that were part of previously selected service chain can't process the request.

Packet Processing Flow

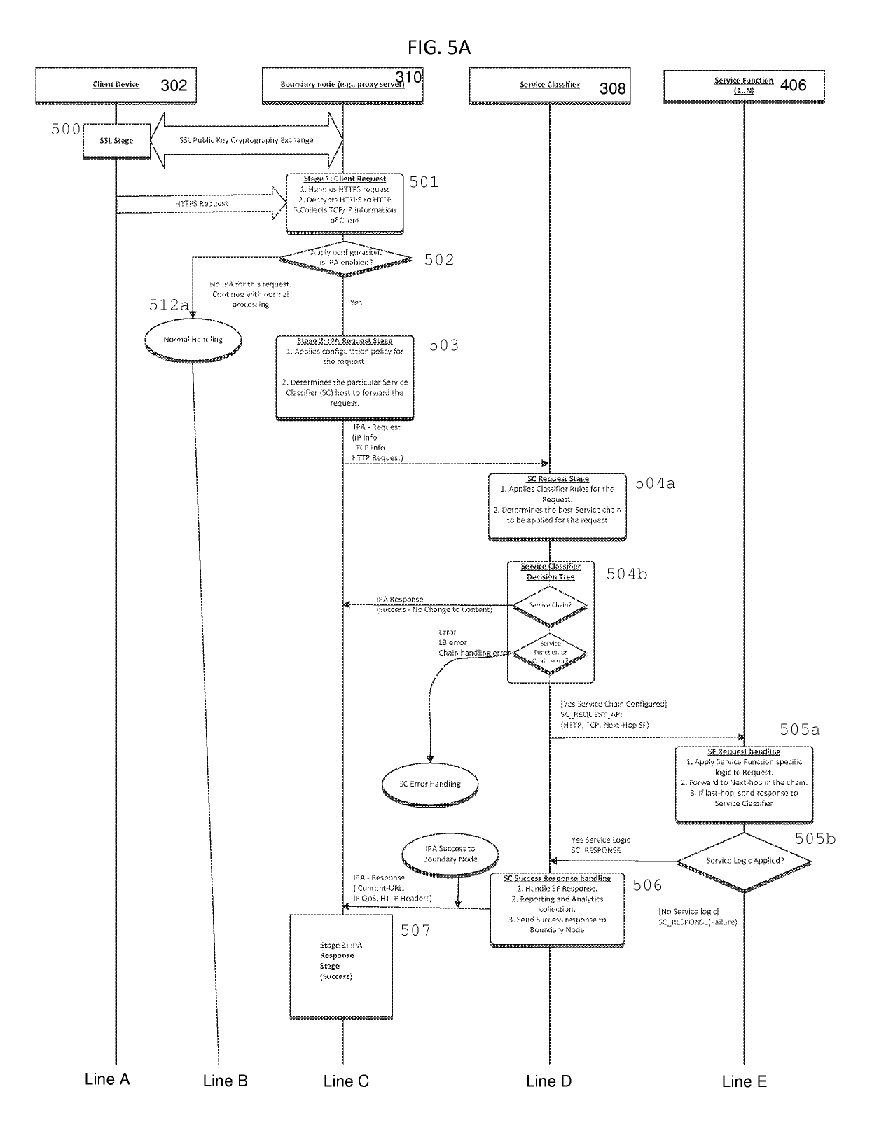

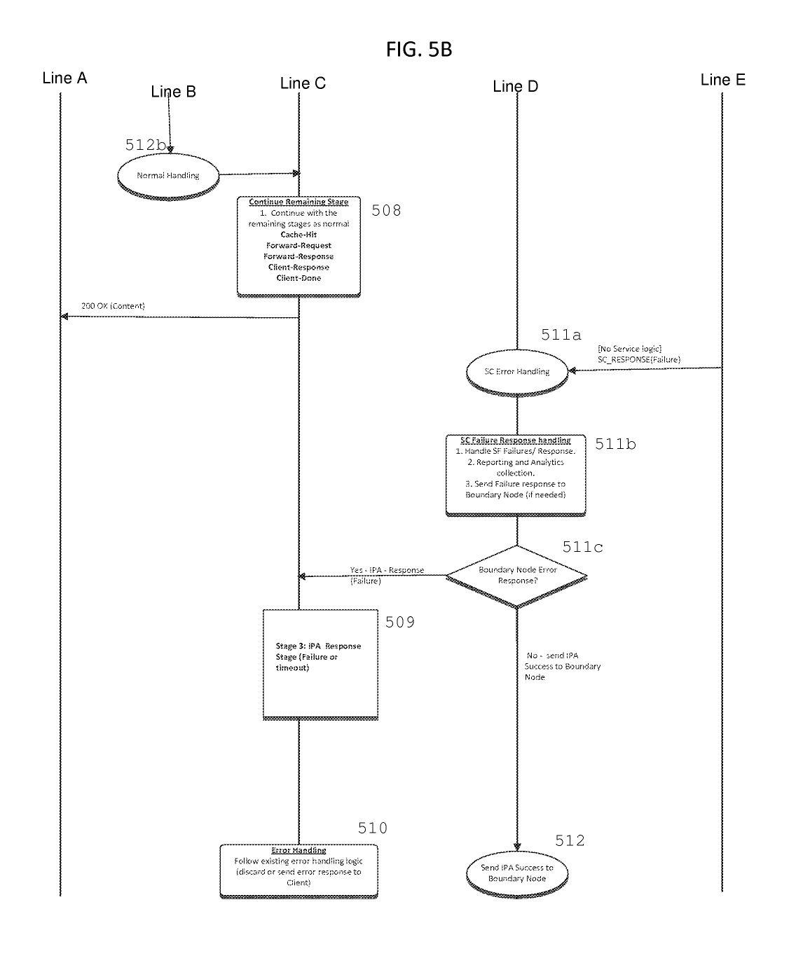

FIGS. 5A-B illustrates packet flow in the example system shown in FIG. 4. As mentioned previously, the boundary node 310 is preferably a proxy server, running for example an HTTP proxy with a local content cache (caching proxy). In the course of handling a client message (e.g., an HTTP request), the proxy server leverages a routine referred to in FIGS. 5A-B as an intermediate processing agent (IPA), which enables the proxy server to initiate a subsidiary processing stage. The IPA stage invokes the service classifier 308 and initiates the service function chain, with the results of SFC processing returned to the proxy server, which then completes its response.

FIGS. 5A-B illustrates the situation where service function chaining is performed on upstream traffic. Along those lines, it illustrates receiving a client device request, invoking an IPA stage and a service function chain on the request and/or data contained therein, and then returning the result for proxy server processing. Then, proxy server processing continues with ‘normal’ processing, e.g., checking cache, making a forward request to origin where there is a cache miss, and the like.

As those skilled in the art will appreciate, to apply service function chaining on downstream traffic (e.g., on a response from an origin server or other server upstream to the boundary node 310), the IPA stage can be invoked after receiving the downstream traffic, and function analogously to what is shown and described with respect to FIGS. 5A-B. The downstream packets can be pushed through a service function chain, and then returned to the proxy server process. Then, the proxy server would transmit them to the client, optionally caching the response for use in responding to subsequent requests if the response is considered cacheable.

Referring to FIG. 5A and in more detail for the upstream case, the process begins with the client device (e.g., a mobile device 302) executing a conventional SSL/TLS handshake with the boundary node/proxy server 310. (See Stage 500.) The client device then sends an encrypted HTTPS request to the proxy server. (Stage 501) The proxy server has the ability to decrypt the traffic. This may be accomplished in a variety of ways, as mentioned previously: for example, the boundary node may have access to the certificate and private key for the origin that the client device is trying to contact, and/or an ability to decrypt traffic as specified in U.S. Patent Publication No. 2013/0156189, the content of which are incorporated by reference. Note that the service platform 300 typically supports content delivery for many different content providers—particularly in the CDN use case—and thus preferably has or has access to the corresponding certificate and SSL/TLS key for each. Thus the proxy server may be able to decrypt traffic that represents requests for content from many different content providers. This itself is a value-add to the network operator, which often does not have the ability to decrypt the traffic as it lacks the necessary security information. Of course, the system can also support unencrypted HTTP traffic (or other application layer traffic).

Returning to FIG. 5A, the proxy server examines the request and applies a configuration setting that specifies how the request should be handled. (Stage 502.) Assume that the configuration dictates that the request should be processed in the service platform 300. Note that in one embodiment, the configuration may be expressed in a configuration file using a flexible metadata language-based approach (written using XML for example) that enables custom configuration for each content provider/network operator. This configuration file may be distributed to proxy servers using a metadata control system established for that purpose. An example of a metadata control system is provided in U.S. Pat. No. 7,240,100, the teachings of which are hereby incorporated by reference.

Assume that based on the configuration, an IPA stage is invoked. (Stage 503.) (Otherwise normal proxy server processing would continue at 512a-b.) The proxy server determines the best service classifier (in the case where there are multiple service classifiers) to forward the request (e.g., based on distance, load, capabilities, originating mobile network & network operator, etc.). IPA stage then proceeds by communicating the request, potentially with certain other information as shown, to the service classifier.

The service classifier applies rules and determines the appropriate service function chain. (SC Request Stage 504a-b.) The classifier invokes the SFC as shown in FIG. 5A, sending the client's request to the first service function instance, along with other information such as IP and TCP header data. The client request is processed node by node in the SFC (505a-b), and if successful returned to the service classifier, which then provides the response to the IPA routine, and also performs logging and analytics. (SC Success Response Handling 506.) As noted previously, in some cases the service platform 300 has a communication channel to the PCRF (see, e.g., FIG. 3, Interface to PCRF and Provisioning/Control 312).

The proxy server finishes the IPA stage successfully and then continues with remaining stages, which are typically conventional proxy server operations like checking local cache for the content, as shown in the Figure. (See Stage 507, 508, 509, 510—Success and Continue Remaining Stage.)

FIGS. 5A-B also illustrate error handling situations in which, for example, the service function instances in the chain fail and/or generate an error response when processing the request. In some cases, these error responses may be propagated up to the proxy server/boundary node process (see SC Failure Response Handling and Stage 511a-c—failure or timeout). In other cases, it is not necessary to tell the proxy server/boundary node, for example because the error response does not affect the response given to the boundary node—so a ‘success’ value is returned from the IPA stage (512).

Content Distribution Networks

One kind of distributed computer system is a “content delivery network” or “CDN” that is operated and managed by a service provider. The service provider typically provides the content delivery service on behalf of third parties. A “distributed system” of this type typically refers to a collection of autonomous computers linked by a network or networks, together with the software, systems, protocols and techniques designed to facilitate various services, such as content delivery or the support of outsourced site infrastructure. This infrastructure is shared by multiple tenants, the content providers. The infrastructure is generally used for the storage, caching, or transmission of content—such as web pages, streaming media and applications—on behalf of such content providers or other tenants. The platform may also provide ancillary technologies used therewith including, without limitation, DNS query handling, provisioning, data monitoring and reporting, content targeting, personalization, and business intelligence.

According to this disclosure, the assets of a CDN platform may be leveraged to provide the service provider platform 300 described above. More details about CDN platforms in general are provided below.

In a known system such as that shown in FIG. 1, a distributed computer system 100 is configured as a content delivery network (CDN) and has a set of servers 102 distributed around the Internet. Typically, most of the servers are located near the edge of the Internet, i.e., at or adjacent end user access networks. A network operations command center (NOCC) 104 may be used to administer and manage operations of the various machines in the system. Third party sites affiliated with content providers, such as web site 106, offload delivery of content (e.g., HTML or other markup language files, embedded page objects, streaming media, software downloads, and the like) to the distributed computer system 100 and, in particular, to the CDN servers (which are sometimes referred to as content servers, or sometimes as “edge” servers in light of the possibility that they are near an “edge” of the Internet). Such servers may be grouped together into a point of presence (POP) 107 at a particular geographic location.

The CDN servers 102 are typically located at nodes that are publicly-routable on the Internet, in end-user access networks, peering points, within or adjacent nodes that are located in mobile networks, in or adjacent enterprise-based private networks, or in any combination thereof

Typically, content providers offload their content delivery by aliasing (e.g., by a DNS CNAME) given content provider domains or sub-domains to domains that are managed by the service provider's authoritative domain name service. The server provider's domain name service directs end user client machines 122 that desire content to the distributed computer system (or more particularly, to one of the CDN servers in the platform) to obtain the content more reliably and efficiently. The CDN servers 102 respond to the client requests, for example by fetching requested content from a local cache, from another CDN server, from the origin server 106 associated with the content provider, or other source, and sending it to the requesting client.

For cacheable content, CDN servers 102 typically employ on a caching model that relies on setting a time-to-live (TTL) for each cacheable object. After it is fetched, the object may be stored locally at a given CDN server until the TTL expires, at which time is typically re-validated or refreshed from the origin server 106. For non-cacheable objects (sometimes referred to as ‘dynamic’ content), the CDN server typically returns to the origin server 106 time when the object is requested by a client. The CDN may operate a server cache hierarchy to provide intermediate caching of customer content in various CDN servers that are between the CDN server handling a client request and the origin server 106; one such cache hierarchy subsystem is described in U.S. Pat. No. 7,376,716, the disclosure of which is incorporated herein by reference.

Although not shown in detail in FIG. 1, the distributed computer system may also include other infrastructure, such as a distributed data collection system 108 that collects usage and other data from the CDN servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115. A distributed data transport mechanism 120 may be used to distribute control information (e.g., metadata to manage content, to facilitate load balancing, and the like) to the CDN servers. The CDN may include a network storage subsystem which may be located in a network datacenter accessible to the CDN servers and which may act as a source of content, such as described in U.S. Pat. No. 7,472,178, the disclosure of which is incorporated herein by reference.

As illustrated in FIG. 2, a given machine 200 in the CDN comprises commodity hardware (e.g., a microprocessor) 202 running an operating system kernel (such as Linux® or variant) 204 that supports one or more applications 206a-n. To facilitate content delivery services, for example, given machines typically run a set of applications, such as an HTTP proxy 207, a name service 208, a local monitoring process 210, a distributed data collection process 212, and the like. The HTTP proxy 207 (sometimes referred to herein as a global host or “ghost”) typically includes a manager process for managing a cache and delivery of content from the machine. For streaming media, the machine may include one or more media servers, such as a Windows® Media Server (WMS) or Flash server, as required by the supported media formats.

A given CDN server 102 shown in FIG. 1 may be configured to provide one or more extended content delivery features, preferably on a domain-specific, content-provider-specific basis, preferably using configuration files that are distributed to the CDN servers using a configuration system. A given configuration file preferably is XML-based and includes a set of content handling rules and directives that facilitate one or more advanced content handling features. The configuration file may be delivered to the CDN server via the data transport mechanism. U.S. Pat. No. 7,240,100, the contents of which are hereby incorporated by reference, describe a useful infrastructure for delivering and managing CDN server content control information and this and other control information (sometimes referred to as “metadata”) can be provisioned by the CDN service provider itself, or (via an extranet or the like) the content provider customer who operates the origin server. U.S. Pat. No. 7,111,057, incorporated herein by reference, describes an architecture for purging content from the CDN. More information about a CDN platform can be found in U.S. Pat. Nos. 6,108,703 and 7,596,619, the teachings of which are hereby incorporated by reference in their entirety.

In a typical operation, a content provider identifies a content provider domain or sub-domain that it desires to have served by the CDN. When a DNS query to the content provider domain or sub-domain is received at the content provider's domain name servers, those servers respond by returning the CDN hostname (e.g., via a canonical name, or CNAME, or other aliasing technique). That network hostname points to the CDN, and that hostname is then resolved through the CDN name service. To that end, the CDN name service returns one or more IP addresses. The requesting client application (e.g., browser) then makes a content request (e.g., via HTTP or HTTPS) to a CDN server machine associated with the IP address. The request includes a host header that includes the original content provider domain or sub-domain. Upon receipt of the request with the host header, the CDN server checks its configuration file to determine whether the content domain or sub-domain requested is actually being handled by the CDN. If so, the CDN server applies its content handling rules and directives for that domain or sub-domain as specified in the configuration. These content handling rules and directives may be located within an XML-based “metadata” configuration file, as mentioned previously.

The CDN platform may be considered an overlay across the Internet on which communication efficiency can be improved. Improved communications on the overlay can help when a CDN server needs to obtain content from an origin server 106, or otherwise when accelerating non-cacheable content for a content provider customer. Communications between CDN servers and/or across the overlay may be enhanced or improved using improved route selection, protocol optimizations including TCP enhancements, persistent connection reuse and pooling, content & header compression and de-duplication, and other techniques such as those described in U.S. Pat. Nos. 6,820,133, 7,274,658, 7,607,062, and 7,660,296, among others, the disclosures of which are incorporated herein by reference.

As an overlay offering communication enhancements and acceleration, the CDN server resources may be used to facilitate wide area network (WAN) acceleration services between enterprise data centers and/or between branch-headquarter offices (which may be privately managed), as well as to/from third party software-as-a-service (SaaS) providers used by the enterprise users.

In this vein CDN customers may subscribe to a “behind the firewall” managed service product to accelerate Intranet web applications that are hosted behind the customer's enterprise firewall, as well as to accelerate web applications that bridge between their users behind the firewall to an application hosted in the internet cloud (e.g., from a SaaS provider).

To accomplish these two use cases, CDN software may execute on machines (potentially in virtual machines running on customer hardware) hosted in one or more customer data centers, and on machines hosted in remote “branch offices.” The CDN software executing in the customer data center typically provides service configuration, service management, service reporting, remote management access, customer SSL/TLS certificate management, as well as other functions for configured web applications. The software executing in the branch offices provides last mile web acceleration for users located there. The CDN itself typically provides CDN hardware hosted in CDN data centers to provide a gateway between the nodes running behind the customer firewall and the CDN service provider's other infrastructure (e.g., network and operations facilities). This type of managed solution provides an enterprise with the opportunity to take advantage of CDN technologies with respect to their company's intranet, providing a wide-area-network optimization solution. This kind of solution extends acceleration for the enterprise to applications served anywhere on the Internet. By bridging an enterprise's CDN-based private overlay network with the existing CDN public internet overlay network, an end user at a remote branch office obtains an accelerated application end-to-end. More information about a behind the firewall service offering can be found in teachings of U.S. Pat. No. 7,600,025, the teachings of which are hereby incorporated by reference.

For live streaming delivery, the CDN may include a live delivery subsystem, such as described in U.S. Pat. No. 7,296,082, and U.S. Publication Nos. 2011/0173345 and 2012/0265853, the disclosures of which are incorporated herein by reference.

Computer Based Implementation

The subject matter described herein may be implemented with computer systems, as modified by the teachings hereof, with the processes and functional characteristics described herein realized in special-purpose hardware, general-purpose hardware configured by software stored therein for special purposes, or a combination thereof

Software may include one or several discrete programs. A given function may comprise part of any given module, process, execution thread, or other such programming construct. Generalizing, each function described above may be implemented as computer code, namely, as a set of computer instructions, executable in one or more microprocessors to provide a special purpose machine. The code may be executed using conventional apparatus—such as a microprocessor in a computer, digital data processing device, or other computing apparatus—as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

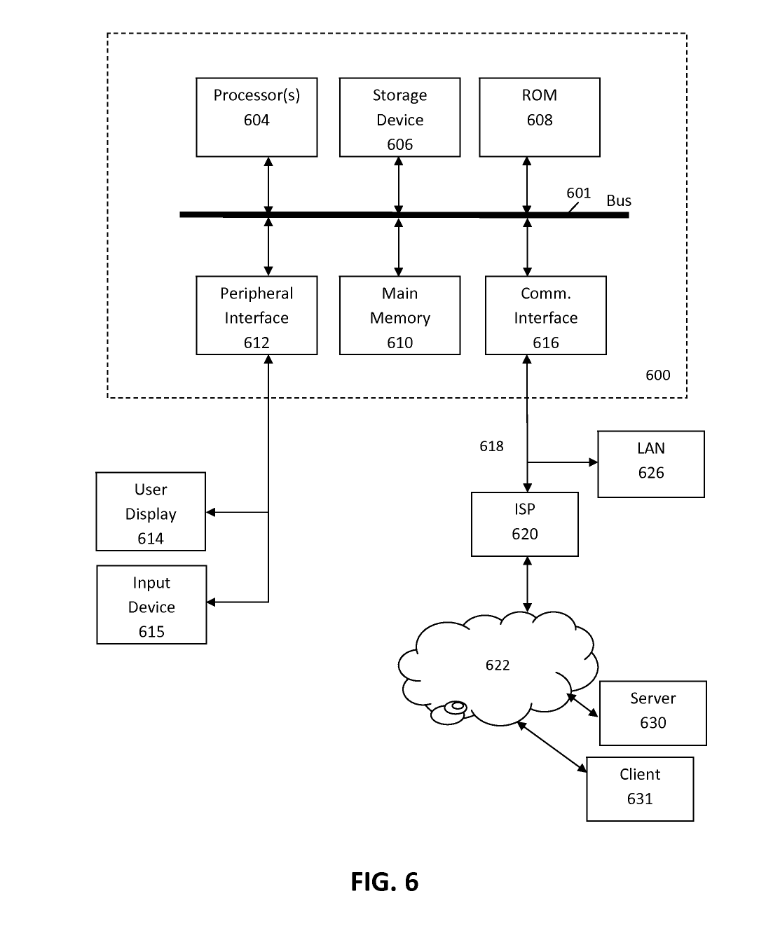

FIG. 6 is a block diagram that illustrates hardware in a computer system 600 on which embodiments of the invention may be implemented. The computer system 600 may be embodied in a client device, server, personal computer, workstation, tablet computer, wireless device, mobile device, network device, router, hub, gateway, or other device.

Computer system 600 includes a microprocessor 604 coupled to bus 601. In some systems, multiple microprocessor and/or microprocessor cores may be employed. Computer system 600 further includes a main memory 610, such as a random access memory (RAM) or other storage device, coupled to the bus 601 for storing information and instructions to be executed by microprocessor 604. A read only memory (ROM) 608 is coupled to the bus 601 for storing information and instructions for microprocessor 604. As another form of memory, a non-volatile storage device 606, such as a magnetic disk, solid state memory (e.g., flash memory), or optical disk, is provided and coupled to bus 601 for storing information and instructions. Other application-specific integrated circuits (ASICs), field programmable gate arrays (FPGAs) or circuitry may be included in the computer system 600 to perform functions described herein.

Although the computer system 600 is often managed remotely via a communication interface 616, for local administration purposes the system 600 may have a peripheral interface 612 communicatively couples computer system 600 to a user display 614 that displays the output of software executing on the computer system, and an input device 615 (e.g., a keyboard, mouse, trackpad, touchscreen) that communicates user input and instructions to the computer system 600. The peripheral interface 612 may include interface circuitry and logic for local buses such as Universal Serial Bus (USB) or other communication links.

Computer system 600 is coupled to a communication interface 616 that provides a link between the system bus 601 and an external communication link. The communication interface 616 provides a network link 618. The communication interface 616 may represent an Ethernet or other network interface card (NIC), a wireless interface, modem, an optical interface, or other kind of input/output interface.

Network link 618 provides data communication through one or more networks to other devices. Such devices include other computer systems that are part of a local area network (LAN) 626. Furthermore, the network link 618 provides a link, via an internet service provider (ISP) 620, to the Internet 622. In turn, the Internet 622 may provide a link to other computing systems such as a remote server 630 and/or a remote client 631. Network link 618 and such networks may transmit data using packet-switched, circuit-switched, or other data-transmission approaches.

In operation, the computer system 600 may implement the functionality described herein as a result of the microprocessor executing program code. Such code may be read from or stored on a non-transitory computer-readable medium, such as memory 610, ROM 608, or storage device 606. Other forms of non-transitory computer-readable media include disks, tapes, magnetic media, CD-ROMs, optical media, RAM, PROM, EPROM, and EEPROM. Any other non-transitory computer-readable medium may be employed. Executing code may also be read from network link 618 (e.g., following storage in an interface buffer, local memory, or other circuitry).

A client device may be a conventional desktop, laptop or other Internet-accessible machine running a web browser or other rendering engine, but as mentioned above a client device may also be a mobile device. Any wireless client device (also referred to as user equipment or UE) may be utilized, e.g., a cellphone, pager, a personal digital assistant (PDA, e.g., with GPRS NIC), a mobile computer with a smartphone client, tablet or the like. Other mobile devices in which the technique may be practiced include any access protocol-enabled device (e.g., iOS™-based device, an Android™-based device, other mobile-OS based device, or the like) that is capable of sending and receiving data in a wireless manner using a wireless protocol. Typical wireless protocols include: WiFi, GSM/GPRS, CDMA, OFDMA, or WiMax. These protocols implement the ISO/OSI Physical and Data Link layers (Layers 1 & 2) upon which a traditional networking stack is built, complete with IP, TCP, SSL/TLS and HTTP. The WAP (wireless access protocol) also provides a set of network communication layers (e.g., WDP, WTLS, WTP) and corresponding functionality used with GSM and CDMA and LTE wireless networks, among others.

Generalizing, a mobile device as used herein is a device that includes a subscriber identity module (SIM), which is a smart card that carries subscriber-specific information, mobile equipment (e.g., radio and associated signal processing devices), a man-machine interface (MMI), and one or more interfaces to external devices (e.g., computers, PDAs, and the like). The mobile device may operate using recognized standard, such as a 3G, 4G, 4G LTE or other. The techniques disclosed herein are not limited for use with a mobile device that uses a particular access protocol. The mobile device typically also has support for wireless local area network (WLAN) technologies, such as Wi-Fi. WLAN is based on IEEE 802.11 standards. The teachings disclosed herein are not limited to any particular mode or application layer for mobile device communications.

It should be understood that the foregoing has presented certain embodiments of the invention that should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought. It will be appreciated by those skilled in the art that the teachings hereof may be realized in methods performed with computing machines, in systems of computing machines with each computing machine comprising at least one microprocessor and memory storing instructions for execution on the at least one microprocessor to cause the system of computing machines to perform a method, and/or in a non-transitory computer readable medium containing instructions for execution by a microprocessor in one or more computing machines that, upon execution, cause the one or more computing machines to perform a method.

It is noted that trademarks appearing herein are the property of their respective owners and used for identification and descriptive purposes only, given the nature of the subject matter at issue, and not to imply endorsement or affiliation in any way.

1. A method of processing packets in a distributed computing platform, the method performed by servers in the distributed computing platform, the method comprising:
establishing an encrypted session between a server in a distributed computing platform and a mobile client device connected to a mobile network, the server being external to the mobile network;
as part of the encrypted session, receiving one or more packets from the mobile client device via a mobile network gateway;
decrypting the one or more packets;
processing data from the one or more packets in a service function chain made of two or more service functions, the processing occurring at one or more servers that provide the service function chain in the distributed computing platform;
sending the processed data from the one or more packets to any of: (i) the mobile client device, via the mobile network gateway and (ii) an origin server that is external to the mobile network and is associated with a content provider.

2. The method of claim 1, comprising sending the processed data from one or more packets to (ii) the origin server that is external to the mobile network and is associated with the content provider.

3. The method of claim 1, wherein the encrypted session is a SSL/TLS session.

4. The method of claim 1, wherein the server in the distributed computing platform does so using any of a private key of a content provider and a public key infrastructure certificate of a content provider.

5. The method of claim 1, wherein processing the data from the one or more packets comprises:
sending the one or more packets through the service function chain, the service function chain being defined by an ordered set of two or more service functions, each service function being performed by a given service function instance, each instance being executed on at least one server in the distributed computing platform.

6. The method of claim 1, wherein the one or more packets include an HTTP request for content of the content provider.

7. The method of claim 1, wherein servers in the distributed computing platform comprise proxy servers with local content caches.

8. The method of claim 1, wherein the mobile network gateway comprises a PDN gateway.

9. A distributed system of servers for processing packets, each server having at least one microprocessor and memory storing instructions for execution on the at least one microprocessor, the distributed system comprising:
a first server in a distributed system that establishes an encrypted session with a mobile client device connected to a mobile network, the first server being external to a mobile network;
as part of the encrypted session, the first server receiving one or more packets from the mobile client device via a mobile network gateway;
the first server decrypting the one or more packets;
one or more second servers that process data from the one or more packets in a service function chain made of two or more service functions;
wherein the first server receives the data processed by the one or more second servers, and the first server sends the processed one or more packets to any of: (i) the mobile client device, via the mobile network gateway and (ii) an origin server that is external to the mobile network and is associated with a content provider.

10. The system of claim 9, wherein the first server sends the processed data from the one or more packets to (ii) the origin server that is external to the mobile network and is associated with the content provider.

11. The system of claim 9, wherein the encrypted session is a SSL/TLS session.

12. The system of claim 9, wherein the one or more second servers process the data from the one or more packets at least by:
sending the one or more packets through the service function chain, the service function chain being defined by an ordered set of two or more service functions, each service function being performed by a given service function instance, each instance being executed on at least one of the second servers in the distributed system.

13. The system of claim 9, wherein the one or more packets include an HTTP request for content of the content provider.

14. A method of providing packet processing services, comprising:
with servers in a distributed computing platform external to a mobile network:
receiving, from an origin server of a content provider, one or more packets;
processing data from the one or more packets in a service function chain made of two or more service functions;
encrypting the processed data from the one or more packets as part of encrypted session established between a given server in the distributed platform and a mobile client device connected to the mobile network;
sending the processed data from the one or more packets to the mobile client device as part of the encrypted session, via a mobile network gateway.

15. The method of claim 14, further comprising sending the processed data from the one or more packets to (ii) the origin server that is external to the mobile network and is associated with the content provider.

16. The method of claim 14, wherein the encrypted session is a SSL/TLS session.

17. The method of claim 14, wherein the given server establishes the encrypted session with the mobile client device using any of a private key of a content provider and a public key infrastructure certificate of a content provider.

18. The method of claim 14, wherein processing the data from the one or more packets comprises:
sending the one or more packets through the service function chain, the service function chain being defined by an ordered set of two or more service functions, each service function being performed by a given service function instance, each instance being executed on at least one server in the distributed computing platform.

19. The method of claim 14, wherein the one or more packets include an HTTP response from the origin server.

20. The method of claim 14, wherein servers in the distributed computing platform comprise proxy servers with local content caches.

21. The method of claim 14, wherein the mobile network gateway comprises a PDN gateway.

22. A distributed system of servers, each server having at least one microprocessor and memory storing instructions for execution on the at least one microprocessor, the distributed system comprising:
a first server in a distributed system that is external to a mobile network, the first server receiving one or more packets from an origin server of a content provider;
one or more second servers that process data from the one or more packets in a service function chain made of two or more service functions;
the first server encrypting the processed data from the one or more packets as part of encrypted session established between the first server and a mobile client device connected to the mobile network;
the first server sending the processed data from the one or more packets to the mobile client device as part of the encrypted session, via a mobile network gateway of the mobile network.

23. The system of claim 22, wherein the encrypted session is a SSL/TLS session.

24. The system of claim 22, wherein processing the data from the one or more packets comprises:
sending the one or more packets through the service function chain, the service function chain being defined by an ordered set of two or more service functions, each service function being performed by a given service function instance, each instance being executed on at least one of the second servers in the distributed system.

25. The system of claim 22, wherein the one or more packets include an HTTP response from the origin server.
